(19) United States
(12) Patent Application Publication
(10) Pub. No.: US 2004/0059832 A1
(43) Pub. Date: Mar. 25, 2004

(54) Mobile radio communications system and method for operating the same

(76) Inventors: Manfred Goretzki, Munchen (DE); Wolfgang Hultsch, Muenchen (DE); Wilhelm Muller, Worth (DE)

Correspondence Address: MORRISON & FOERSTER LLP, 1650 TYSONS BOULEVARD, SUITE 300, MCLEAN, VA, 22102, US

(21) Appl. No.: 10/296,816

(22) PCT Filed: May 22, 2001
(86) PCT No.: PCT/DE01/01971

(30) Foreign Application Priority Data
Jun. 6, 2000 (DE) 100 27 872.8

(51) Int. Cl. G06F 15/16

(52) U.S. Cl. 709/246; 709/249

(57) ABSTRACT

The invention relates to a mobile radio communications system that comprises a mobile switching center (MSC) established between a radio network range (UTRAN) of the mobile radio communications system and a fixed network range (CN), adapted to exchange transport and control data with the radio network range (UTRAN) and control data with the fixed network range (CN). A media gateway (MGW) for adapting the format of the transport data to be transmitted between the fixed network range (CN) and the radio network range (UTRAN) is disposed between the mobile switching center (MSC) and the fixed network (CN).

The invention relates to a mobile radio communications system and a method for operating the same.

Mobile radio systems, like the GSM system already available on the market or the UMTS system currently being developed, are known. A great deal of development work at present focuses on making such mobile radio communications systems multimedia capable. Key concepts here are the “internet mobile”, with which it is claimed that it will be possible to retrieve internet content with a level of speed and convenience at least equal to that of traditional access by computer and data transfer using conventional line-connected telecommunications networks, the WAP or Wireless Application Protocol and others.

One problem encountered when trying to make different services available in mobile radio communications systems is the wide range of data formats or transfer protocols which are used to transfer the data between the individual terminals depending on the content of the data. This wide range is necessary due to the different requirements for the transfer of different data types. While voice transfer imposes exacting requirements with regard to the speed and uniformity of the transfer, although the bandwidth of the voice scan and therefore the transfer can be varied as required, to take into account changing transmission and receiving conditions at the site of the mobile terminals, when transferring files or internet content a flow of data can be tolerated, which is not uniform over time; however using bandwidth limitation to restrict the quantity of data to be transferred is not an option. It is therefore necessary to take into account the nature of the data to be transferred, when transferring data within the mobile radio communications system between the transmitting and receiving terminal and this data, hereafter referred to as transport data, must also be transferred along with additional data, which provides information about the nature of the transport data, where appropriate the coding used to generate it, etc., which is hereafter referred to, together with what is known as the signaling data required to establish the line and for switching purposes, as the “control data”.

During the transfer between the radio and the fixed network range of a mobile radio communications system adaptation of the format of this transport data may be necessary or desirable in the interests of efficient management of network resources. The transfer between the radio network range and the fixed network range is set up by mobile switching centers, also referred to as MSC.

In the 1999 release of the UMTS standard, published by 3GPP (3^{rd} Generation Partnership Project) under the name “3G TS 23.002 V3.3.0 (2000-03); Technical Specification Group Services and Systems Aspects; Network Architecture” MSCs are used, which correspond to GSM-standard MSCs with only slight changes. The functions of transport data switching using a switching matrix and control data processing as well as mobility management (referred to as call processing) are carried out in these MSCs.

In order to increase the flexibility of the mobile radio communications systems and simplify their adaptation for the transfer of transport data of a different type, in the 2000 release of the UMTS standard (publication 3GPP TR 23.922 V1.0.0 (1999-10) entitled “Technical Specification Group Services and Systems Aspects; Architecture for an all IP network” published by 3^{rd} Generation Partnership Project, Sophia Antipolis, France (http://www.3gpp.org) MSCs are proposed, in which the transport and control functions of conventional MSCs are allocated to two function units. These function units are referred to as the media gateway MGW and the MSC server.

The purpose of this proposal in particular is to achieve the broadest possible independence of the switching devices from the basic structure of the system, such as ATM (Asynchronous Transfer Mode) or IP (Internet Protocol) by integrating the transport functions, which are relatively closely linked to the basic structure, in one function unit, while the management functions of call processing, which depend to a lesser degree on the basic structure, are carried out by a specific function unit, the structure and mode of operation of which are only determined to a lesser extent by the basic structure of the system and which can therefore easily be transferred from one communications system to another.

One disadvantage of this proposal is however that this division into two separate function groups for transport and control involves considerable development costs and can only be implemented in already existing mobile communications systems with significant outlay. Conversion of an existing MSC to an MSC server, for example, requires the separation of the switching matrix, conventionally located in the MSC; a new connection is required for communication between the MSC server and media gateway, the connection for various signal tones must be redefined and various performance features, which require a close interaction between control and transport, such as a three-way conference, have to be redefined.

The object of the invention is to specify a mobile radio communications system and a method for operating a mobile radio communications system, which allow the transfer of different types of transport data in a flexible fashion, without requiring extensive conversion of the existing mobile radio communications networks.

This object is achieved by the mobile radio communications system with the features in claim 1 and the method with the features in claim 4.

Advantageous embodiments are set out in dependent claims.

In the mobile radio communications system according to the invention a mobile switching center or MSC is provided, which receives both transport data and related control data from a radio network range of the mobile radio communications system or transfers it to this, and which exchanges transport data with the fixed network range of the mobile radio communications system via a media gateway, which carries out any necessary conversions of the format of the transport data on the basis of parameters set by related control data.

Like the MSCs in the known GSM system, an MSC of this type operates with two interfaces, a first interface for the exchange of transport and control data with the radio network range and a second for the exchange of transport and control data with the fixed network range, with the transport data, which is carried via this second interface, being transferred via the media gateway, before it reaches the fixed network range, where necessary with a converted format.

A specific interface for communication with the media gateway is not required.

This structure therefore allows the continued use of MSCs in already operating mobile radio communications systems with only minor adaptations. Investments made by the mobile radio operators in their networks are therefore protected and the objective of greater flexibility, allowing the transfer of different types of data, is still achieved.

An embodiment is described in more detail below using the drawings. These show:

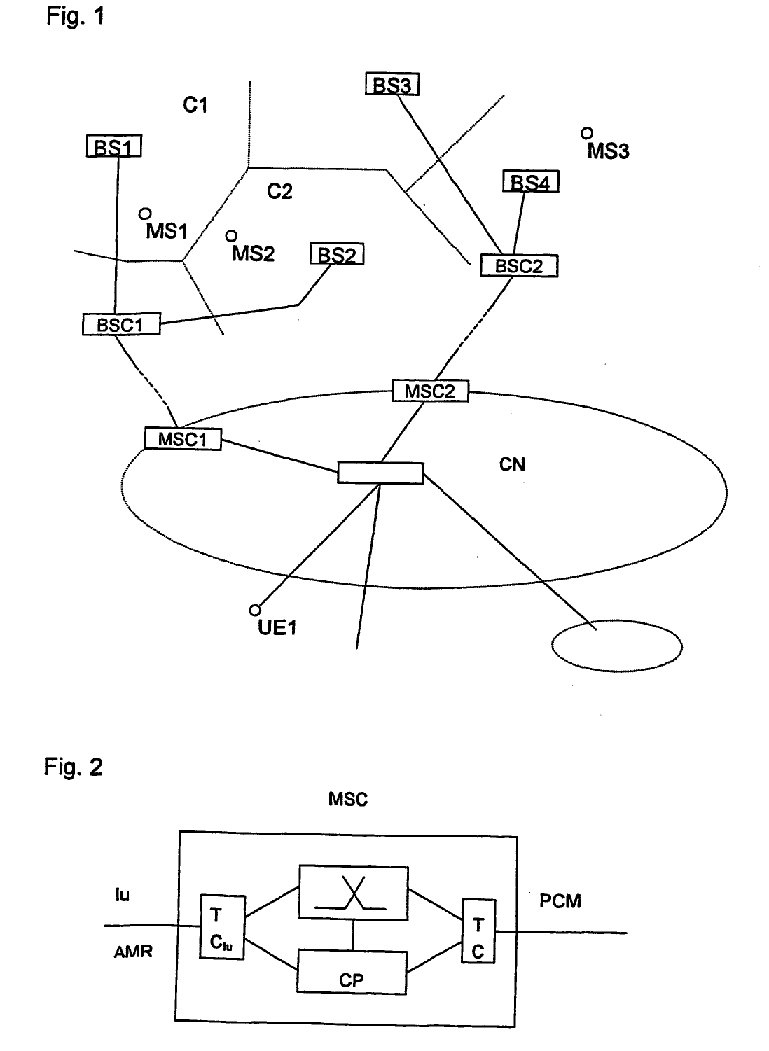

FIG. 1 a diagrammatic representation of the structure of a mobile radio communications system, in which the present invention can be used;

FIG. 2 for comparison, an MSC, the structure of which corresponds to the 1999 release of the UMTS standard;

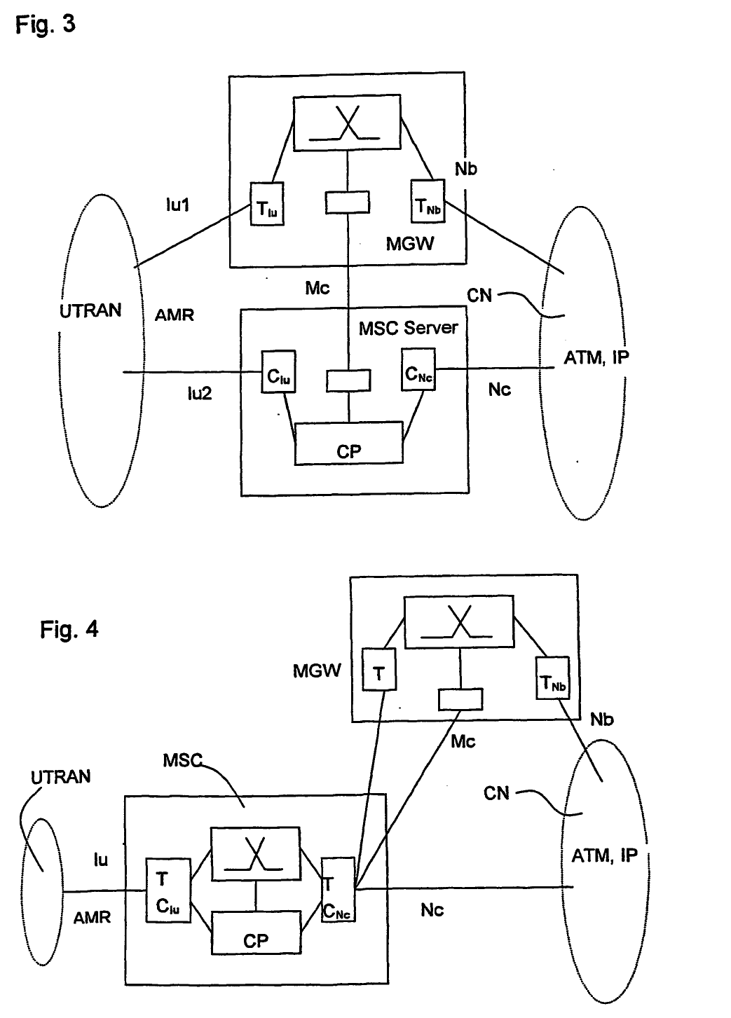

FIG. 3 for comparison, an MSC server and a media gateway MGW according to the 2000 release of the UMTS standard; and

FIG. 4 an MSC with media gateway according to the present invention.

FIG. 1 shows the hierarchical structure of a mobile radio communications system, in which the present invention can be used. Such a mobile radio communications system contains a system-wide arrangement of geographical cells C1, C2, etc., each of which corresponds to the range of the radio signal from base stations BS1, BS2, etc., which communicate with mobile terminals MS1, MS2, etc., which are located in the respective cells C1, C2, etc.

A plurality of base stations BS1, BS2, etc., are each assigned to a base station controller BSC1, BSC2 and the base station controllers are each connected via intermediate stages (not shown) to a mobile switching center MSC1, MSC2. The mobile switching centers switch connections between mobile terminals, when both are located in cells, which are each assigned to the same mobile switching center, for instance the terminals MS1 and MS2 of cells C1 and C2 in FIG. 1, both of which are in cells assigned to the MSC1.

Connections between terminals, which are in cells not assigned to the same MSC, are switched via a fixed network range of the mobile radio communications system, referred to here as CN for core network. Such terminals may be mobile terminals in cells not assigned to the same MSC, such as the terminals MS1 and MS3, or one of the terminals may be a line-connected terminal, such as the terminal UE1 connected directly to CN.

FIG. 2 shows the structure of an MSC according to the known 1999 release of the UMTS standard. The MSC has two interfaces, which are shown respectively in the figure with the letters TC for Transport and Control, because they are provided for the exchange of both transport data, i.e. for example voice data or file transfers, and also control data, i.e. signaling data and data about the type and, where necessary, the coding of the transport data. The interface to the radio network range is for example an Iu interface TC_{Iu}, which exchanges AMR coded signals with the radio network range of the mobile radio communications system according to the 3GPP Iu interface specification (see, for example, publication 3G TS 25.410, “Technical Specification Group Radio Access Network; UTRAN Iu Interface: General Aspects and Principles” from 3GPP). The other interface is a PCM interface for the exchange of data with the fixed network range.

Incoming data is divided by the interface into control data, which is forwarded to a call processing unit CP, which controls the switching matrix of the MSC, and transport data, which passes through the switching matrix towards the other interface in each instance.

FIG. 3 shows the transition between the radio and fixed network ranges of a mobile radio communications system according to the 2000 release of the UMTS standard. The MSC here is replaced by what is referred to as an MSC server and a media gateway MGW. The MSC server exchanges control data via an Iu² interface C_{Iu} with the radio network range UTRAN and via an Nc interface C_{Nc} with the fixed network range CN. This data is analyzed in a call processing unit CP of the MSC server or forwarded to the other range of the mobile radio communications system in each instance. The interface C_{Iu} uses the RANAP (Radio Access Network Application Part) protocol when communicating with the radio network range UTRAN.

Transport data is exchanged between the radio network range UTRAN and the fixed network range CN via the media gateway MGW. For this the MGW has an interface T_{Iu} with the radio network range UTRAN, via which the transport data is transferred according to protocols such as AAL2 or—particularly for real time multimedia applications—RTP (Real Time Protocol).

A second interface with the fixed network range is referred to as T_{Nb} and can, for example, operate in outward communication with the protocol stack RTP/UDP (User Datagram Protocol)/IP (Internet Protocol).

Transport data is switched between the interfaces via a switching matrix, which is controlled by the MSC server via a third, specialized interface Mc.

FIG. 4 shows the transition between the radio and fixed network ranges of a mobile radio communications system according to the present invention. It is formed by an MSC of essentially conventional structure, as shown in FIG. 2, with a shared interface TC_{Iu} for the exchange of transport and control data with the radio network range UTRAN, a second interface TC_{Nc} for the exchange of data with the fixed network range CN and a switching matrix controlled by a call processing unit CP.

Unlike the structure shown in FIG. 2, the transition according to FIG. 4 also has a media gateway MGW with its own switching matrix, as shown in FIG. 3. However its interfaces T are not directly connected to UTRAN or a specialized interface for the exchange of data with the radio network range UTRAN and control interface Nc, as shown in FIG. 3, but are all connected to the fixed network side interface TC_{Nc} of the MSC.

The MSC can therefore handle transport data which is to be transferred from the radio network range into the fixed network range, associated signaling data and control data for the media gateway, as data which is to be switched to three different receivers, namely the fixed network CN (or a terminal to be reached via the fixed network), the interface T or the interface Mc of the media gateway MGW. The format of the transport data which it receives from the radio network range, is largely irrelevant to the MSC, as any necessary format conversions are dealt with by interfaces of the media gateway in accordance with the control data received after passage of this data through the MSC.

For the same reason it is not necessary to adapt the structure of the MSC to the structure used for forwarding transport data in the fixed network range CN. It is only necessary for the media gateway to be able to process the transport data format supplied by the MSC. Intermediate connection of an MGW makes it possible to continue to operate already operating MSCs, whether the fixed network range with which they interact is an IP network, an ATM network or any other.

The invention is described above specifically in relation to a UTMS telecommunications system but can also be used as it stands in a GSM system.

1. Mobile radio communications system with a mobile switching center (MSC) located between a radio network range (UTRAN) of the mobile radio communications system and a fixed network range (CN) for the exchange of transport and control data with the radio network range (UTRAN) and of control data with the fixed network range (CN), characterized in that a media gateway (MGW) is located between the mobile switching center (MSC) and the fixed network range (CN) to adapt the format of transport data to be exchanged between the fixed network range (CN) and the radio network range (UTRAN).

2. Mobile radio communications system according to claim 1, characterized in that it is a UMTS telecommunications system or a GSM telecommunications system.

3. Mobile radio communications system according to claim 1 or 2, characterized in that the mobile switching center (MSC) has a standard interface (TC_{Nc}) for the transfer of transport and control data to and from the fixed network range (CN), via which control data is transferred both into the fixed network range (CN) for direct forwarding to a remote communication partner and into the media gateway (MGW) to be processed by this.

4. Method for transferring data between a first terminal (MS1) connected to a radio network range of a mobile radio communications system and a second terminal (MS3, UE1) with the aid of a mobile switching center (MSC), which is located between the radio network range (UTRAN) of the mobile radio communications system and a fixed network range (CN), and with which control and transport data from the terminals (MS3, UE1) pass through the mobile switching center (MSC), characterized in that the mobile switching center (MSC) forwards data to be transferred to the second terminal (MS3, UE1) via a media gateway (MGW) located between the mobile switching center (MSC) and the fixed network range to adapt the format of the transport data to the requirements of the fixed network range (CN) or of the second terminal (MS3, UE1).
